(19) United States
(12) Patent Application Publication
(10) Pub. No.: US 2024/0430002 A1
(43) Pub. Date: Dec. 26, 2024

(54) Ranging or Sensing Method and Apparatus

(71) Applicant: Huawei Technologies Co., Ltd., Shenzhen (CN)

(72) Inventors: Chenchen Liu, Shenzhen (CN); Peng Liu, Shenzhen (CN); Xun Yang, Singapore (SG)

(21) Appl. No.: 18/828,418

(22) Filed: Sep. 9, 2024

Related U.S. Application Data
(63) Continuation of application No. PCT/CN2023/078621, filed on Feb. 28, 2023.

(30) Foreign Application Priority Data
Mar. 9, 2022 (CN) 202210225706.2

(51) Int. Cl. H04B 7/26; G01S 13/76

(52) U.S. Cl. CPC H04B 7/2612; G01S 13/765

(57) ABSTRACT

A ranging or sensing method comprising performing clear channel assessment (CCA) on an ultra-wideband (UWB) channel to obtain first indication information, where the first indication information indicates at least two first idle time segments in one time unit; and sending at least one segment signal of a first UWB signal in a first target idle time segment in each time unit, where the first UWB signal is for performing data measurement, and the at least two first idle time segments include the first target idle time segment.

### CROSS-REFERENCE TO RELATED APPLICATIONS

This is a continuation of International Patent Application No. PCT/CN2023/078621, filed on Feb. 28, 2023, which claims priority to Chinese Patent Application No. 202210225706.2, filed on Mar. 9, 2022. The disclosures of the aforementioned applications are hereby incorporated by reference in their entireties.

### TECHNICAL FIELD

Embodiments of this application relate to the communication field, and more specifically, to a ranging or sensing method and apparatus.

### BACKGROUND

An ultra-wideband (UWB) technology is a wireless carrier communication technology in which nanosecond-level non-sinusoidal narrow impulse are used for data transmission. Due to a narrow impulse and extremely low radiation spectral density, a UWB system has advantages of a strong multipath resolution capability, low power consumption, high confidentiality, and the like.

In a ranging or sensing scenario, precision of a measurement or sensing result is greatly related to signal bandwidth. Larger signal bandwidth indicates higher precision of a result obtained through sensing or ranging. Therefore, it may be considered that a reference signal for ranging or sensing is received and sent by using the UWB system, and another reference signal and/or data are/is transmitted according to a narrowband protocol. This processing manner may be understood as narrowband protocol-assisted UWB ranging or sensing.

In a narrowband protocol-assisted UWB ranging or sensing process, an initiator device performs round trip time measurement with a responder device on a UWB channel in a segment transmission manner. If a plurality of pairs of initiator devices and responder devices simultaneously perform UWB ranging or sensing, transmission time of a plurality of consecutive segment signals easily overlaps. This interferes with a ranging result and affects ranging performance.

### SUMMARY

Embodiments of this application provide a ranging or sensing method, to avoid a case in which transmission time of a plurality of consecutive segment signals overlaps when a plurality of pairs of initiator devices and responder devices simultaneously perform UWB ranging or sensing. This avoids ranging interference and improves ranging performance.

According to a first aspect, a ranging or sensing method is provided. The method may be performed by an initiator device, or may be performed by a component (for example, a chip or a circuit) of the initiator device. This is not limited. For ease of description, an example in which the method is performed by the initiator device is used below for description.

The method includes performing clear channel assessment (CCA) on an UWB channel to obtain first indication information, where the first indication information indicates at least two first idle time segments in one time unit; and sending at least one segment signal of a first UWB signal in a first target idle time segment in each time unit, where the first UWB signal is used to perform data measurement, and the at least two first idle time segments include the first target idle time segment.

Based on the foregoing solution, before sending the first UWB signal, the initiator device first performs CCA (for example, performs CCA within time of one millimeter), and determines, based on a result of CCA, a time segment for sending the first UWB signal in segment. In this way, the first UWB signal is sent in the idle time segment, to avoid overlapping with transmission time of a plurality of other consecutive segment signals. This avoids ranging interference and improves ranging performance.

With reference to the first aspect, in some implementations of the first aspect, the sending at least one segment signal of a first UWB signal in a first target idle time segment in each time unit includes sending one segment signal of the first UWB signal in the first target idle time segment in each time unit.

With reference to the first aspect, in some implementations of the first aspect, after the performing CCA on a UWB channel, the method further includes sending a first frame on a narrowband channel, where the first frame is used to trigger data measurement.

Based on the foregoing solution, the initiator device may trigger data measurement in a triggering form of the first frame. This avoids an overhead waste caused by continuous channel listening.

With reference to the first aspect, in some implementations of the first aspect, the first frame includes at least one of the following information such as the first indication information, identification information of a responder device, information indicating duration of the first UWB signal in each time unit, information indicating an interval between time at which the first frame is sent and time at which the first UWB signal is sent, information indicating a quantity of segments of the first UWB signal, information indicating a total length of the first UWB signal, and information indicating a data measurement result feedback type.

The first frame may include a plurality of types of information, to help the responder device learn of a transmission status of the first UWB signal for data measurement, and determine, based on the transmission status of the first UWB signal, whether a data measurement procedure is successfully performed.

With reference to the first aspect, in some implementations of the first aspect, the method further includes receiving a second frame on the first narrowband channel, where the second frame is used to respond to the first frame.

Based on the foregoing solution, the initiator device may determine, when receiving the second frame that responds to the first frame and that is fed back by the responder device, that data measurement can be performed. This ensures that data measurement is successfully performed.

With reference to the first aspect, in some implementations of the first aspect, the method further includes receiving a second UWB signal on the UWB channel, where the second UWB signal is used to perform data measurement.

Based on the foregoing solution, after triggering data measurement, the initiator device completes data measurement based on the first UWB signal and the second UWB signal, and obtains a data measurement result.

According to a second aspect, a ranging or sensing method is provided. The method may be performed by a responder device, or may be performed by a component (for example, a chip or a circuit) of the responder device. This is not limited. For ease of description, the following uses an example in which the method is performed by the responder device for description.

The method includes receiving at least one segment signal of a first UWB signal in a first target idle time segment in each time unit; performing CCA on a UWB channel to obtain second indication information, where the second indication information indicates at least two second idle time segments in one time unit; sending at least one segment signal of a second UWB signal in a second target idle time segment in each time unit, where the at least two second idle time segments include the second target idle time segment; and performing data measurement based on the first UWB signal and the second UWB signal.

Based on the foregoing solution, before sending the second UWB signal, the responder device first performs channel assessment detection for one millisecond, and determines, based on a result of channel assessment detection, a time sequence for sending the second UWB signal in segments. In this way, the second UWB signal is sent in the idle time segment, to avoid overlapping with transmission time of a plurality of other consecutive segment signals. This avoids ranging interference and improves ranging performance.

With reference to the second aspect, in some implementations of the second aspect, the sending at least one segment signal of a second UWB signal in a second target idle time segment in each time unit includes sending one segment signal of the second UWB signal in the second target idle time segment in each time unit.

With reference to the second aspect, in some implementations of the second aspect, the method further includes receiving a first frame on a narrowband channel, where the first frame is used to trigger data measurement.

Based on the foregoing solution, the responder device may start to perform data measurement after receiving the first frame sent by an initiator device, to avoid an overhead waste caused by continuous channel listening.

With reference to the second aspect, in some implementations of the second aspect, the first frame includes at least one of the following information such as first indication information, identification information of the responder device, information indicating duration of the first UWB signal in each time unit, information indicating an interval between time at which the first frame is sent and time at which the first UWB signal is sent, information indicating a quantity of segments of the first UWB signal, information indicating a total length of the first UWB signal, and information indicating a data measurement result feedback type. The first indication information indicates at least two first idle time segments in one time unit, and the second target idle time segment is different from the first target idle time segment.

The first frame may include a plurality of types of information, to help the responder device learn of a transmission status of the first UWB signal for data measurement, and determine, based on the transmission status of the first UWB signal, whether a data measurement procedure is successfully performed.

With reference to the second aspect, in some implementations of the second aspect, the method further includes sending a second frame on the narrowband channel, where the second frame is used to respond to the first frame.

Based on the foregoing solution, the responder device feeds back the second frame in response to the first frame to the initiator device, so that the initiator device learns that data measurement can be performed, to ensure that data measurement is successfully performed.

According to a third aspect, a ranging or sensing apparatus is provided. The apparatus is configured to perform the method provided in the first aspect.

The apparatus includes a processing unit, configured to perform CCA on UWB channel to obtain first indication information, where the first indication information indicates at least two first idle time segments in one time unit; and a transceiver unit, configured to send at least one segment signal of a first UWB signal in a first target idle time segment in each time unit, where the first UWB signal is used to perform data measurement, and the at least two first idle time segments include the first target idle time segment.

With reference to the third aspect, in some implementations of the third aspect, the transceiver unit is further configured to send one segment signal of the first UWB signal in the first target idle time segment in each time unit.

With reference to the third aspect, in some implementations of the third aspect, after performing CCA on the UWB channel, the transceiver unit is further configured to send a first frame on a narrowband channel, where the first frame is used to trigger data measurement.

With reference to the third aspect, in some implementations of the third aspect, the first frame includes at least one of the following information such as the first indication information, identification information of a responder device, information indicating duration of the first UWB signal in each time unit, information indicating an interval between time at which the first frame is sent and time at which the first UWB signal is sent, information indicating a quantity of segments of the first UWB signal, information indicating a total length of the first UWB signal, and information indicating a data measurement result feedback type.

With reference to the third aspect, in some implementations of the third aspect, the transceiver unit is further configured to receive a second frame on the narrowband channel, where the second frame is used to respond to the first frame.

With reference to the third aspect, in some implementations of the third aspect, the transceiver unit is further configured to receive a second UWB signal on the UWB channel, where the second UWB signal is used to perform data measurement.

For beneficial effect of the method shown in the third aspect and the possible designs of the third aspect, refer to beneficial effect of the first aspect and the possible designs of the first aspect.

According to a fourth aspect, a ranging or sensing apparatus is provided. The apparatus is configured to perform the method provided in the second aspect.

The apparatus includes a transceiver unit, configured to receive at least one segment signal of a first UWB signal in a first target idle time segment in each time unit; and a processing unit, configured to perform CCA on an UWB channel to obtain second indication information, where the second indication information indicates at least two second idle time segments in one time unit. The transceiver unit is further configured to send at least one segment signal of a second UWB signal in a second target idle time segment in each time unit, where the at least two second idle time segments include the second target idle time segment. The processing unit is further configured to perform data measurement based on the first UWB signal and the second UWB signal.

With reference to the fourth aspect, in some implementations of the fourth aspect, the transceiver unit is further configured to send one segment signal of the second UWB signal in the second target idle time segment in each time unit.

With reference to the fourth aspect, in some implementations of the fourth aspect, the transceiver unit is further configured to receive a first frame on a narrowband channel, where the first frame is used to trigger data measurement.

With reference to the fourth aspect, in some implementations of the fourth aspect, the first frame includes at least one of the following information such as first indication information, identification information of a responder device, information indicating duration of the first UWB signal in each time unit, information indicating an interval between time at which the first frame is sent and time at which the first UWB signal is sent, information indicating a quantity of segments of the first UWB signal, information indicating a total length of the first UWB signal, and information indicating a data measurement result feedback type. The first indication information indicates at least two first idle time segments in one time unit, and the second target idle time segment is different from the first target idle time segment.

With reference to the fourth aspect, in some implementations of the fourth aspect, the transceiver unit is further configured to send a second frame on the narrowband channel, where the second frame is used to respond to the first frame.

For beneficial effect of the apparatus shown in the fourth aspect and the possible designs of the fourth aspect, refer to the beneficial effect in the second aspect and the possible designs of the second aspect.

According to the communication methods provided in the first aspect and the second aspect, CCA is performed before the UWB signals are sent, so that the initiator device and the responder device separately send the UWB signal in an idle time segment based on results of CCA of the initiator device and the responder device, to avoid overlapping with transmission time of another segment signal. This avoids ranging interference, and improves ranging performance. This application further provides another communication method. The initiator device and the responder device separately send a UWB signal in a random time segment based on a time sequence including a random number, to avoid overlapping with transmission time of another segment signal. This avoids ranging interference and improves ranging performance. The following describes the communication method with reference to the fifth aspect and the sixth aspect.

According to a fifth aspect, a ranging or sensing method is provided. The method may be performed by an initiator device, or may be performed by a component (for example, a chip or a circuit) of the initiator device. This is not limited. For ease of description, an example in which the method is performed by the initiator device is used below for description.

The method includes sending a first UWB signal on an UWB channel based on a first time sequence, where the first UWB signal includes N first segment signals, the first time sequence includes N elements, an i^{th} element indicates that sending time of an i^{th} first segment signal is located in a k^{th} time segment in an i^{th} time unit, any time unit is divided into K time segments, i is a positive integer less than or equal to N, and k is a random number less than or equal to K; and receiving a second UWB signal on the UWB channel, where the first UWB signal and the second UWB signal are used to perform data measurement.

Based on the foregoing technical solution, the initiator device sends the first UWB signal in a segment sending manner on a random time segment based on a time sequence including a random number, to avoid overlapping with transmission time of a plurality of other consecutive segment signals. This avoids ranging interference and improves ranging performance.

With reference to the fifth aspect, in some implementations of the fifth aspect, the method further includes generating the first time sequence based on a first key.

Based on the foregoing technical solution, the first time sequence may be generated based on the first key with low signaling overheads. This improves flexibility of the solution, and reduces signaling overheads because the first key occupies small memory.

With reference to the fifth aspect, in some implementations of the fifth aspect, before the sending a first UWB signal, the method further includes sending a first frame on a narrowband channel. The first frame includes the first time sequence, and the first frame is used to trigger data measurement.

Based on the foregoing solution, the initiator device may trigger data measurement in a triggering form of the first frame. This avoids an overhead waste caused by continuous channel listening. In addition, the first time sequence is sent to a responder device by using the first frame, so that the responder device can determine, based on the first time sequence, a random time sequence for sending the second UWB signal. This improves flexibility of the solution.

With reference to the fifth aspect, in some implementations of the fifth aspect, before the sending a first UWB signal, the method further includes sending the first frame on the narrowband channel. The first frame includes the first key, and the first frame is used to trigger data measurement.

Based on the foregoing solution, the initiator device may trigger data measurement in a triggering form of the first frame. This avoids an overhead waste caused by continuous channel listening. In addition, the first key is sent to the responder device by using the first frame, so that the responder device can determine the first time sequence based on the first key, and then determine, based on the first time sequence, the random time sequence for sending the second UWB signal. This improves flexibility of the solution. In addition, this can reduce signaling overheads because the first key occupies small memory.

With reference to the fifth aspect, in some implementations of the fifth aspect, the first frame further includes at least one of the following information such as identification information of the responder device, information indicating a quantity of segments of the first UWB signal, information indicating a total length of the first UWB signal, and information indicating a data measurement result feedback type.

The first frame may include a plurality of types of information, to help the responder device learn of a transmission status of the first UWB signal for data measurement, and determine, based on the transmission status of the first UWB signal, whether a data measurement procedure is successfully performed.

With reference to the fifth aspect, in some implementations of the fifth aspect, when a time interval at which two adjacent first segment signals are sent is less than a first threshold, a guard interval is inserted between the time interval at which the two adjacent first segment signals are sent. The guard interval is equal to the first threshold.

Based on the foregoing technical solution, when the time interval at which the two adjacent segment signals are sent is less than the first threshold (for example, 1 millisecond), the initiator device inserts a guard interval whose time length is the first threshold (for example, 1 millisecond) between the time interval at which the two segment signals are sent, to ensure that the time interval at which the two segment signals are sent is not less than 1 millisecond.

According to a sixth aspect, a ranging or sensing method is provided. The method may be performed by a responder device, or may be performed by a component (for example, a chip or a circuit) of the responder device. This is not limited. For ease of description, the following uses an example in which the method is performed by the responder device for description.

The method includes receiving a first UWB signal on a UWB channel; and sending a second UWB signal on the UWB channel based on a second time sequence, where the first UWB signal and the second UWB signal are used to perform data measurement. The second time sequence is generated based on a first time sequence. The first time sequence includes N elements, an i^{th} element indicates that sending time of an i^{th} second segment signal is located in a k^{th} time segment in an i^{th} time unit, any time unit is divided into K time segments, i is a positive integer less than or equal to N, and k is a random number less than or equal to K.

Based on the foregoing technical solution, the responder device sends the second UWB signal in a segment sending manner on a random time segment based on a time sequence including a random number, to avoid overlapping with transmission time of a plurality of other consecutive segment signals. This avoids ranging interference and improves ranging performance.

With reference to the sixth aspect, in some implementations of the sixth aspect, the method further includes generating the first time sequence based on a first key.

Based on the foregoing technical solution, the first time sequence may be generated based on the first key with low signaling overheads. This improves flexibility of the solution, and reduces signaling overheads because the first key occupies small memory.

With reference to the sixth aspect, in some implementations of the sixth aspect, before the receiving a first UWB signal, the method further includes receiving a first frame on a narrowband channel, where the first frame includes the first time sequence, and the first frame is used to trigger data measurement.

Based on the foregoing solution, the responder device may start to perform data measurement after receiving the first frame sent by an initiator device, to avoid an overhead waste caused by continuous channel listening. In addition, the responder device can determine, based on the first time sequence carried in the first frame, a random time sequence for sending the second UWB signal. This improves flexibility of the solution.

With reference to the sixth aspect, in some implementations of the sixth aspect, before the receiving a first UWB signal, the method further includes receiving the first frame on the narrowband channel, where the first frame includes the first key, and the first frame is used to trigger data measurement.

Based on the foregoing solution, the responder device may start to perform data measurement after receiving the first frame sent by the initiator device, to avoid an overhead waste caused by continuous channel listening. In addition, the responder device can determine the first time sequence based on the first key carried in the first frame, and then determine, based on the first time sequence, the random time sequence for sending the second UWB signal. This improves flexibility of the solution. In addition, this can reduce signaling overheads because the first key occupies small memory.

With reference to the sixth aspect, in some implementations of the sixth aspect, the first frame further includes at least one of the following information such as identification information of the responder device, information indicating a quantity of segments of the first UWB signal, information indicating a total length of the first UWB signal, and information indicating a data measurement result feedback type.

The first frame may include a plurality of types of information, to help the responder device learn of a transmission status of the first UWB signal for data measurement, and determine, based on the transmission status of the first UWB signal, whether a data measurement procedure is successfully performed.

According to a seventh aspect, a ranging or sensing apparatus is provided. The apparatus is configured to perform the method provided in the fifth aspect.

The apparatus includes a transceiver unit, configured to send a first UWB signal on an UWB channel based on a first time sequence. The first UWB signal includes N first segment signals, the first time sequence includes N elements, an i^{th} element indicates that sending time of an i^{th} first segment signal is located in a k^{th} time segment in an i^{th} time unit, any time unit is divided into K time segments, i is a positive integer less than or equal to N, and k is a random number less than or equal to K. The transceiver unit is further configured to receive a second UWB signal on the UWB channel. The first UWB signal and the second UWB signal are used to perform data measurement.

With reference to the seventh aspect, in some implementations of the seventh aspect, a processing unit is further configured to generate the first time sequence based on a first key.

With reference to the seventh aspect, in some implementations of the seventh aspect, before sending the first UWB signal, the processing unit is further configured to send a first frame on a narrowband channel. The first frame includes the first time sequence, and the first frame is used to trigger data measurement.

With reference to the seventh aspect, in some implementations of the seventh aspect, before sending the first UWB signal, the processing unit is further configured to send the first frame on the narrowband channel. The first frame includes the first key, and the first frame is used to trigger data measurement.

With reference to the seventh aspect, in some implementations of the seventh aspect, the first frame further includes at least one of the following information such as identification information of a responder device, information indicating a quantity of segments of the first UWB signal, information indicating a total length of the first UWB signal, and information indicating a data measurement result feedback type.

With reference to the seventh aspect, in some implementations of the seventh aspect, when a time interval at which two adjacent first segment signals are sent is less than a first threshold, the processing unit is further configured to insert a guard interval between the time interval at which the two adjacent first segment signals are sent. The guard interval is equal to the first threshold.

For beneficial effect of the method shown in the seventh aspect and the possible designs of the seventh aspect, refer to the beneficial effect in the fifth aspect and the possible designs of the fifth aspect.

According to an eighth aspect, a ranging or sensing apparatus is provided. The apparatus is configured to perform the method provided in the sixth aspect.

The apparatus includes a transceiver unit, configured to receive a first UWB signal on a UWB channel. The transceiver unit is further configured to send a second UWB signal on the UWB channel based on a second time sequence. The first UWB signal and the second UWB signal are used to perform data measurement. The second time sequence is generated based on a first time sequence. The first time sequence includes N elements, an i^{th} element indicates that sending time of an i^{th} second segment signal is located in a k^{th} time segment in an i^{th} time unit, any time unit is divided into K time segments, i is a positive integer less than or equal to N, and k is a random number less than or equal to K.

With reference to the eighth aspect, in some implementations of the eighth aspect, a processing unit is configured to generate the first time sequence based on a first key.

With reference to the eighth aspect, in some implementations of the eighth aspect, before receiving the first UWB signal, the transceiver unit is further configured to receive a first frame on a narrowband channel. The first frame includes the first time sequence, and the first frame is used to trigger data measurement.

With reference to the eighth aspect, in some implementations of the eighth aspect, before receiving the first UWB signal, the transceiver unit is further configured to receive the first frame on the narrowband channel. The first frame includes the first key, and the first frame is used to trigger data measurement.

With reference to the eighth aspect, in some implementations of the eighth aspect, the first frame further includes at least one of the following information such as identification information of a responder device, information indicating a quantity of segments of the first UWB signal, information indicating a total length of the first UWB signal, and information indicating a data measurement result feedback type.

According to a ninth aspect, a ranging or sensing apparatus is provided. The apparatus is configured to perform the method provided in the first aspect or the fifth aspect. In an example, the communication apparatus may include units and/or modules configured to perform the method provided in any one of the foregoing implementations of the first aspect or the fifth aspect, for example, a processing unit and an obtaining unit.

In an implementation, a transceiver unit may be a transceiver or an input/output interface, and the processing unit may be at least one processor. Optionally, the transceiver may be a transceiver circuit. Optionally, the input/output interface may be an input/output circuit.

In another implementation, the transceiver unit may be an input/output interface, an interface circuit, an output circuit, an input circuit, a pin, a related circuit, or the like on a chip, a chip system, or a circuit; and the processing unit may be at least one processor, a processing circuit, a logic circuit, or the like.

According to a tenth aspect, a ranging or sensing apparatus is provided. The apparatus is configured to perform the method provided in the second aspect or the sixth aspect. In an example, the communication apparatus may include units and/or modules configured to perform the method provided in the second aspect or the sixth aspect, for example, a processing unit and an obtaining unit.

In an implementation, a transceiver unit may be a transceiver or an input/output interface, and the processing unit may be at least one processor. Optionally, the transceiver may be a transceiver circuit. Optionally, the input/output interface may be an input/output circuit.

In another implementation, a transceiver unit may be an input/output interface, an interface circuit, an output circuit, an input circuit, a pin, a related circuit, or the like on a chip, a chip system, or a circuit; and the processing unit may be at least one processor, a processing circuit, a logic circuit, or the like.

According to an eleventh aspect, this application provides a processor, configured to perform the methods provided in the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this application.

According to a twelfth aspect, a computer-readable storage medium is provided. The computer-readable storage medium stores program code to be executed by a device, and the program code is used to perform the method provided in any one of the implementations of the first aspect, the second aspect, the fifth aspect, and the sixth aspect.

According to a thirteenth aspect, a computer program product including instructions is provided. When the computer program product runs on a computer, the computer is enabled to perform the method provided in any one of the implementations of the first aspect, the second aspect, the fifth aspect, and the sixth aspect.

According to a fourteenth aspect, a chip is provided. The chip includes a processor and a communication interface. The processor reads, through the communication interface, instructions stored in a memory, to perform the method provided in any one of the implementations of the first aspect, the second aspect, the fifth aspect, and the sixth aspect.

Optionally, in an implementation, the chip further includes the memory. The memory stores a computer program or the instructions. The processor is configured to execute the computer program or the instructions stored in the memory. When the computer program or the instructions are executed, the processor is configured to perform the method provided in any one of the implementations of the first aspect, the second aspect, the fifth aspect, and the sixth aspect.

### BRIEF DESCRIPTION OF DRAWINGS

FIG. 1A and FIG. 1B are diagrams of application scenarios according to this application;

FIG. 2A is a diagram of a UWB signal according to an embodiment of this application;

FIG. 2B is a diagram of an architecture of a ranging and positioning system according to an embodiment of this application;

FIG. 3 is a diagram of a UWB ranging method according to an embodiment of this application;

FIG. 4 is a schematic flowchart of a communication method according to an embodiment of this application;

FIG. 5 is a schematic flowchart of a communication method according to an embodiment of this application;

FIG. 6 is a diagram of a sending time sequence of UWB signals based on CCA according to an embodiment of this application;

FIG. 7 is a schematic flowchart of a communication method according to an embodiment of this application;

FIG. 8 is a diagram of a sending time sequence of UWB signals based on time hopping according to an embodiment of this application;

FIG. 9 is a block diagram of a communication apparatus according to an embodiment of this application; and

FIG. 10 is a block diagram of a communication device according to an embodiment of this application.

### DESCRIPTION OF EMBODIMENTS

The following describes technical solutions of this application with reference to accompanying drawings.

Embodiments of this application may be applied to a wireless personal area network (WPAN). Currently, a standard used for the WPAN is the Institute of Electrical and Electronics Engineers (IEEE) 802.15 series. The WPAN may be used for communication between digital auxiliary devices in a small range, such as a telephone, a computer, and an auxiliary device, and a working range of the WPAN is usually within 10 meters (m). Technologies supporting the wireless personal area network include BLUETOOTH, ZIGBEE, UWB, IrDA infrared connection technology (infrared), HOMERF, and the like. From a perspective of network composition, the WPAN is located at a bottom layer of an entire network architecture and is for a wireless connection between devices in a small range, that is, a point-to-point short-range connection, and may be considered as a short-range wireless communication network. Based on different application scenarios, WPANs are further classified into a high rate (HR)-WPAN and a low rate (LR)-WPAN. The HR-WPAN may be used to support various high-rate multimedia applications, including high-quality sound image delivery, multi-megabyte music and image document transmission, and the like. The LR-WPAN may be for common services in daily life.

In the WPAN, devices may be classified into a full-function device (FFD) and a reduced-function device (RFD) based on communication capabilities of the devices. The FFD devices can communicate with each other, and the FFD device and the RFD device can communicate with each other. The RFD devices cannot directly communicate with each other, and can only communicate with the FFD devices, or forward data externally through one FFD device. The FFD device associated with the RFD is referred to as a coordinator of the RFD. The RFD device is mainly for a simple control application, like a light switch and a passive infrared sensor. A small amount of data is transmitted, and a small quantity of transmission resources and communication resources are occupied. Therefore, costs of the RFD device are low. The coordinator may also be referred to as a personal area network (PAN) coordinator, a central control node, or the like. The PAN coordinator is a main control node of an entire network, and each ad hoc network can have only one PAN coordinator which has a member identity management, link information management, and packet forwarding function. Optionally, the device in embodiments of this application may be a device that supports a plurality of WPAN standards, such as IEEE 802.15.4a, IEEE 802.15.4z, and a currently discussed version or a later version.

In embodiments of this application, the device may be a communication server, a router, a switch, a bridge, a computer, a mobile phone, a home smart device, a vehicle-mounted communication device, or the like.

In embodiments of this application, the device includes a hardware layer, an operating system layer running above the hardware layer, and an application layer running above the operating system layer. The hardware layer includes hardware such as a central processing unit (CPU), a memory management unit (MMU), and a memory (also referred to as a main memory). The operating system may be any one or more types of computer operating systems that implement service processing through a process, for example, a LINUX operating system, a UNIX operating system, an ANDROIS operating system, an iOS operating system, or a WINDOWS operating system. The application layer includes applications such as a browser, an address book, word processing software, and instant messaging software. In addition, a specific structure of an execution body of the method provided in embodiments of this application is not specially limited in embodiments of this application, provided that a program that records code of the method provided in embodiments of this application can be run to perform communication according to the method provided in embodiments of this application. For example, the method provided in embodiments of this application may be performed by the FFD or the RFD, or a functional module that can invoke and execute a program in the FFD or the RFD.

In addition, aspects or features of this application may be implemented as a method, an apparatus, or a product that uses standard programming and/or engineering technologies. The term “product” used in this application covers a computer program that can be accessed from any computer-readable component, carrier or medium. For example, the computer-readable medium may include but is not limited to a magnetic storage component (for example, a hard disk, a floppy disk or a magnetic tape), an optical disc (for example, a compact disc (CD), or a digital versatile disc (DVD)), a smart card and a flash memory component (for example, erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel, and various other media that can store, contain, and/or carry an instruction and/or data.

Alternatively, embodiments of this application are applicable to a wireless local area network system, like an internet of things (IoT) network or a vehicle-to-everything (V2X). In an example, embodiments of this application are further applicable to other possible communication systems, for example, a long term evolution (LTE) system, an LTE frequency division duplex (, FDD) system, an LTE time division duplex (TDD) system, a universal mobile telecommunication system (UMTS), a worldwide interoperability for microwave access (WiMAX) communication system, a 5th generation (5G) communication system, and a future 6th generation (6G) communication system.

The foregoing communication systems applicable to this application are merely examples for descriptions, and the communication systems applicable to this application are not limited thereto. This is uniformly described herein, and details are not described below again.

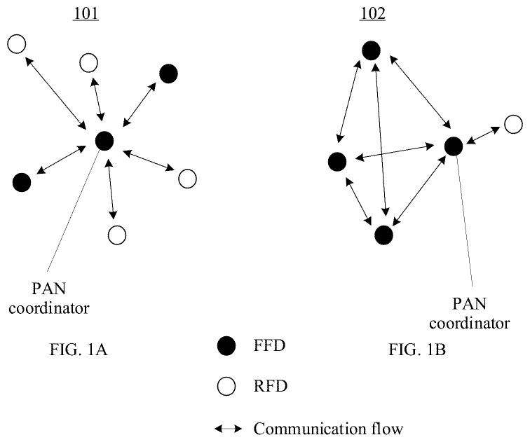

FIGS. 1A and 1B are diagrams of two application scenarios according to this application. In a system 101 shown in FIG. 1A, a plurality of FFD devices and a plurality of RFD devices form a communication system with a star topology (star topology), where one FFD is a PAN controller. In the communication system with the star topology, the PAN controller performs data transmission with one or more other devices, in other words, a one-to-many or many-to-one data transmission architecture may be established between the plurality of devices. In a system 102 shown in FIG. 1A, a plurality of FFD devices and one RFD device form a communication system with a peer-to-peer topology, where one FFD is a PAN controller. In the communication system with the peer-to-peer topology, a many-to-many data transmission architecture may be established between the plurality of different devices.

It should be understood that in FIG. 1A and FIG. 1B are merely simplified diagrams for ease of understanding, and do not constitute a limitation on an application scenario of this application. For example, the system 101 and/or the system 102 may further include another FFD and/or another RFD.

For ease of understanding of the technical solutions in embodiments of this application, some terms or concepts that may be used in embodiments of this application are first briefly described.

1. UWB technology: A UWB technology is a wireless carrier communication technology in which nanosecond-level non-sinusoidal narrow impulses are used for data transmission. Therefore, a UWB occupies a wide spectral range. Due to a narrow impulse and extremely low radiation spectral density, a UWB system has advantages of a strong multipath resolution capability, low power consumption, high confidentiality, and the like.

As the Federal Communications Commission (FCC) approved entry of the UWB technology into the civil field in 2002, UWB wireless communication has become one of the popular physical layer technologies for short-range and high-speed wireless networks. Many world-renowned companies, research institutes, and standardization organizations are actively engaged in the research, development, and standardization of UWB wireless communication technologies. The IIEEE has incorporated the UWB technology into its IEEE 802 series wireless standards, and has released a UWB technology-based WPAN standard IEEE 802.15.4a and an evolved version IEEE 802.15.4z. Currently, a next-generation UWB technology-based WPAN standard IEEE 802.15.4ab has been put on the agenda.

Because the UWB technology performs data transmission through receiving and sending of nanosecond-level or sub-nanosecond-level and extremely narrow impulses rather than using a carrier in a conventional communication system, the UWB technology has a high requirement on time synchronization of a transceiver device. In addition, due to large communication bandwidth of the UWB technology, the devices have high power consumption and complexity when a signal is received and sent on an UWB channel, and most UWB communication devices are driven by a battery. It is expected to further reduce power consumption of the UWB system in a next generation standard. Therefore, all signals except ranging and sensing reference signals are received and sent in a narrowband system in a narrowband signal-assisted manner. This reduces overall power consumption overheads.

2. Power of a UWB signal: Due to large bandwidth of an UWB system, during operating, to reduce interference to another narrowband device, an FCC imposes strict restrictions on power spectral density of UWB signals. According to the Code of Federal Regulations (CFR), there are two rules provided below.

Rule 1: An average value of maximum power spectral density (PSD) of transmitted UWB signals within one millisecond cannot be greater than 41.3 decibel-milliwatt (dBm) per megahertz (MHz).

Rule 2: Maximum power of the transmitted UWB signals in any 50 MHz bandwidth cannot exceed 1 milliwatt.

Rule 1 limits total energy transmitted by a UWB within one millisecond (for example, 37 nanojoule (nJ) in a case of 500 MHz bandwidth). The energy is transmitted in shorter time. This increases instantaneous power of a transmit signal, enlarges signal coverage, and increases a signal-to-noise ratio of a signal received at a receiving end. Based on this, in some scenarios in which transmit power needs to be increased, a transmitting end divides a to-be-transmitted UWB signal into a plurality of segment signals, where a time length of each segment signal is less than one millisecond, and then sends only one segment signal in each millisecond.

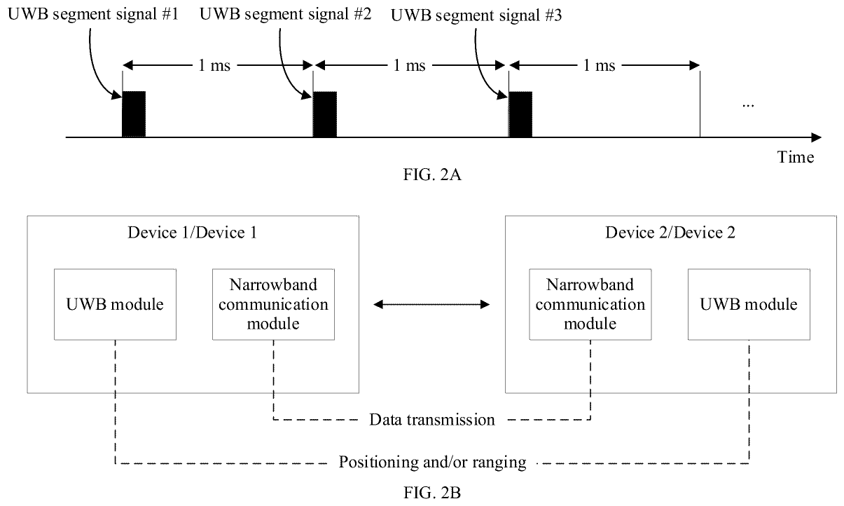

For ease of understanding, a UWB signal is briefly described with reference to FIG. 2A. FIG. 2A is a diagram of a UWB signal according to an embodiment of this application.

It can be seen from FIG. 2A that, a transmitting end divides a to-be-transmitted UWB signal into a plurality of segment signals (a UWB segment signal #1, a UWB segment signal #2, and a UWB segment signal #3 shown in FIG. 2A), a time length of each segment signal is less than one millisecond, and only one segment signal is sent in each millisecond. The segment signal may be referred to as a segment for short.

It can be learned from the foregoing that, the to-be-transmitted UWB signal is divided into the plurality of segment signals for segment transmission. This can increase instantaneous power of the UWB signal, but cannot increase the instantaneous power infinitely. Rule 2 actually limits a power increase multiple for UWB-based segment transmission.

3. Impulse radio ultra-wideband (IR-UWB) system: Due to large bandwidth of an UWB system, a device of the UWB system needs to have an ultra-high-speed data receiving and sending capability. However, spectral efficiency of the IR-UWB system based on impulse transmission is low, and when same information is transmitted, power consumption overheads required by an IR-UWB solution are much higher than those of another narrowband short-range protocol (for example, BLUETOOTH or ZIGBEE).

4. Ranging or sensing: In a ranging or sensing scenario, precision of a measurement or sensing result is related to signal bandwidth. Larger signal bandwidth indicates higher precision of a result obtained through sensing or ranging. Therefore, it may be considered that a reference signal for ranging or sensing is received and sent by using a UWB system, and another reference signal and/or data is transmitted according to a narrowband protocol. This can ensure ranging and sensing precision, and also reduce power consumption. Sensing in this application may be understood as a bottom-layer sensing technology in an IoT technology architecture, and is a primary step for obtaining information and implementing object control in IoT. Ranging may be understood as measurement of a distance between devices, including but not limited to measurement of a distance between two objects in IoT.

For ease of understanding, with reference to FIG. 2B, a ranging and positioning system to which the foregoing ranging technology is applied is briefly described. FIG. 2B is a diagram of an architecture of the ranging and positioning system according to an embodiment of this application. As shown in FIG. 2B, the ranging and positioning system includes a plurality of devices (for example, a device 1 and a device 2 in (FIG. 2B), and may be an apparatus in this embodiment of this application. Each device includes at least a UWB module and a narrowband communication module. Positioning and/or ranging may be performed between UWB modules in the device 1 and the device 2, and data transmission may be performed between narrowband communication modules in the device 1 and the device 2 through a radio link.

In this application, the UWB module may be understood as an apparatus, a chip, a system, or the like that implements a UWB wireless communication technology. Correspondingly, the narrowband communication module may be understood as an apparatus, a chip, a system, or the like that implements a narrowband communication technology (for example, WI-FI, BLUETOOTH, or ZIGBEE protocols). In one device, a UWB module and a narrowband communication module may be different apparatuses or chips. In an example, the UWB module and the narrowband communication module may alternatively be integrated into one apparatus or chip. Embodiments of this application do not limit an implementation of the UWB module and the narrowband communication module in the device. The UWB technology can enable a communication apparatus to have a high data throughput and enable apparatus positioning to have high precision.

The device in this application may be a wireless communication chip, a wireless sensor, or a wireless communication terminal, for example, a user terminal, a user apparatus, an access apparatus, a subscriber station, a subscriber unit, a mobile station, a user agent, and user equipment that support a WI-FI communication function. The user terminal may include various handheld devices, vehicle-mounted devices, wearable devices, IoT devices, or computing devices that have a wireless communication function, or another processing device connected to a wireless modem, user devices (UE) of various forms, a mobile station (MS), a terminal, terminal equipment), a portable communication device, a handheld device, a portable computing device, an entertainment device, a game device or system, a global positioning system device, or any other appropriate device configured to perform network communication via a wireless medium. In addition, the device supports IEEE 802.15.4ab or a next-generation standard of IEEE 802.15.4ab. The device further supports a plurality of standards, such as IEEE 802.15.4a, IEEE 802.15.4-2011, IEEE 802.15.4-2015, and IEEE 802.15.4z. The device may further support a plurality of wireless local area network (WLAN) standards of the IEEE 802.11 family such as IEEE 802.11ax, IEEE 802.11ac, IEEE 802.11n, IEEE 802.11g, IEEE 802.11b, IEEE 802.11a, and a next generation of IEEE 802.11be.

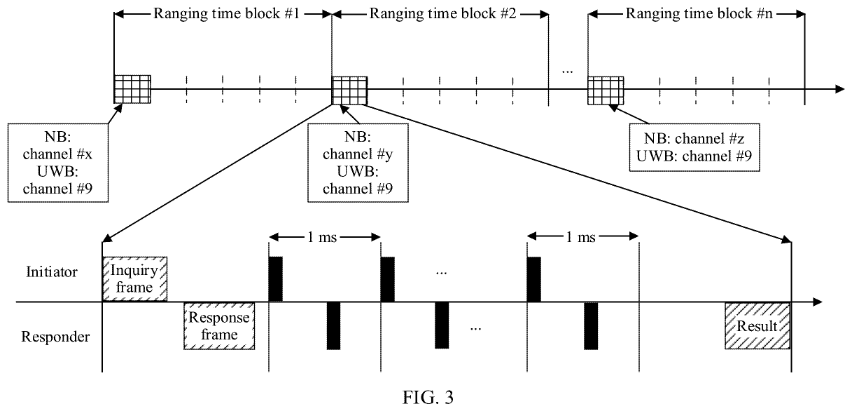

For ease of understanding, with reference to FIG. 3, the following briefly describes a narrowband protocol-assisted UWB ranging method. FIG. 3 is a diagram of the UWB ranging method according to an embodiment of this application.

It can be seen from FIG. 3 that, a transceiver device completes round-trip measurement by using UWB signals, to implement high-precision ranging, and completes negotiation of a ranging task and feedback of a ranging result through a narrowband protocol. An example procedure includes the following steps.

The device performs narrowband-assisted UWB ranging once in each ranging time block (ranging block) (for example, a ranging time block #1, a ranging time block #2, and a ranging time block #n shown in FIG. 3). In each ranging time block (for example, the ranging time block #2 shown in FIG. 3), a narrowband system works on a same channel (for example, a channel #9 shown in FIG. 3). In different ranging time blocks, the narrowband system may change an operating channel (for example, a channel #x corresponding to the ranging time block #1, a channel #y corresponding to the ranging time block #2, and a channel #z corresponding to the ranging time block #n shown in FIG. 3) in a frequency hopping manner. This avoids a complex channel access solution.

In an example, in each ranging procedure, an initiator sends an inquiry (poll) frame to a responder, and the responder replies with a response (resp) frame after receiving the inquiry frame. After receiving the response frame, the initiator performs round-trip time measurement with the responder on a UWB channel in a segment transmission manner. After the measurement is completed, the responder sends a measurement result (report) to the initiator by using the narrowband system.

The foregoing describes, with reference to FIG. 1, a scenario to which embodiments of this application can be applied, further describes the basic concepts in this application, and describes a UWB ranging method with reference to FIG. 3. However, if a plurality of pairs of initiators and responders simultaneously perform UWB ranging or sensing, segment transmission time may overlap. This causes interference to a ranging process.

To resolve a problem existing in the foregoing UWB ranging method, this application provides a communication method, to avoid a case in which transmission time of a plurality of consecutive segment signals overlaps when a plurality of pairs of initiators and responders simultaneously perform UWB ranging or sensing. This avoids ranging interference and improves ranging performance. The following describes the communication method provided in this application with reference to the accompanying drawings.

A specific structure of an execution body of the method provided in embodiments of this application is not particularly limited in the following embodiments, provided that communication can be performed according to the method provided in embodiments of this application by running a program that records code of the method provided in embodiments of this application. For example, the method provided in embodiments of this application may be performed by a transceiver device, or a functional module that is in a transceiver device and that can invoke and execute the program.

For ease of understanding of embodiments of this application, the following descriptions are provided.

First, in this application, “indicate” may be understood as “enable”, and “enable” may include “directly enable” and “indirectly enable”. When a piece of information is described to enable A, the information may directly enable A or indirectly enable A, but it does not mean that the information definitely carries A.

Information enabled by the information is referred to as to-be-enabled information. In an example implementation process, the to-be-enabled information may be enabled in many manners, for example, but not limited to, the to-be-enabled information may be directly enabled, such as the to-be-enabled information or an index of the to-be-enabled information. Alternatively, the to-be-enabled information may be indirectly enabled by enabling other information, where there is an association relationship between the other information and the to-be-enabled information. Alternatively, only a part of the to-be-enabled information may be enabled, and other parts of the to-be-enabled information are known or agreed in advance. For example, specific information may be enabled through a pre-agreed (for example, specified in a protocol) sequence of all information, to reduce enabling overheads to some extent. In addition, a common part of all information may be identified and enabled in a unified manner, to reduce enabling overheads caused by enabling same information separately.

Second, various numeric numbers such as first and second (for example, “#1” and “#2”) shown in this application are merely for ease of description, and are used to distinguish between objects, but are not intended to limit the scope of embodiments of this application. For example, the numeric numbers are used to differentiate between different channels, but are not for describing a specific order or sequence. It should be understood that objects described in such a way are interchangeable in an appropriate circumstance, so that a solution other than embodiments of this application can be described.

Third, in this application, “preconfigured” may include “predefined”, for example, defined in a protocol. “Predefined” may be implemented in a manner of storing corresponding code, a table or other related information that may be used for indication in a device (for example, including network elements) in advance. A specific implementation of “predefined” is not limited in this application.

Fourth, “store” in embodiments of this application may mean that stored in one or more memories. The one or more memories may be separately disposed, or may be integrated into an encoder or a decoder, a processor, or a communication apparatus. Alternatively, a part of the one or more memories may be separately disposed, and a part of the one or more memories are integrated into the decoder, the processor, or the communication apparatus. A type of the memory may be a storage medium in any form. This is not limited in this application.

Fifth, the term “and/or” in this specification is merely an association relationship for describing associated objects, and indicates that three relationships may exist. For example, A and/or B may indicate the following three cases such as Only A exists, both A and B exist, and only B exists. In addition, the character “/” in this specification usually indicates an “or” relationship between associated objects.

Sixth, a “protocol” in embodiments of this application may be a standard protocol in the communication field, for example, may include a Wi-Fi protocol, and a related protocol applied to a future communication system. This is not limited in this application.

Without loss of generality, the following describes in detail the communication method provided in embodiments of this application by using interaction between an initiator device and a responder device as an example.

By way of example, and not limitation. The initiator device may be a device having a communication capability in a WPAN, for example, an FFD or an RFD. Similarly, the responder device may also be a device having a communication capability in a WPAN, for example, an FFD or an RFD.

It should be understood that specific types of the initiator device and the responder device are not limited in this application, provided that both are communication devices having a UWB signal receiving and sending capability.

FIG. 4 is a schematic flowchart of a communication method according to an embodiment of this application. The method includes the following steps.

S410: An initiator device performs CCA on a UWB channel to obtain first indication information.

In an example, the initiator device performs CCA on the UWB channel. The CCA is used to detect usage of the UWB channel in one time unit. The initiator device determines the first indication information based on the usage of the UWB channel in the time unit, and the first indication information indicates at least two first idle time segments in one time unit.

For example, a process in which the initiator device performs CCA is as follows such as an initiator device receives a UWB signal, and calculates power of the received UWB signal in real time. When the power of the received UWB signal is greater than a specific threshold, it is considered that the channel is busy in a short period of time and is being used by another device. If the power of the received UWB signal is less than the threshold, it is considered that the channel is idle in a short period of time. The power of the received UWB signal is calculated and compared with the threshold.

It should be noted that the foregoing description is merely an example for describing how the initiator device performs CCA, and constitutes no limitation on the protection scope of this application. A specific principle of performing the CCA by the initiator device is not limited in embodiments of this application. For details, refer to current related descriptions of clear channel detection.

The time unit is equal to a first threshold in terms of time length.

Optionally, the first threshold may be predefined, or may be determined by a transceiver device through negotiation.

The first threshold includes but is not limited to 1 millisecond, 0.5 millisecond, and the like. A specific value of the first threshold is not limited in embodiments of this application. For example, the value of the first threshold may be adjusted and set based on factors such as maximum power spectral density of a transmitted UWB signal and a power increase multiple for UWB-based segment transmission.

It should be understood that any time unit is divided into K time segments, where K is a positive integer. For example, if a time length of a time unit is 1 millisecond, and the time unit is divided into five time segments, a time length of each time segment is 0.2 millisecond.

For example, the initiator device detects, in a blind detection manner, a time segment for signal transmission in an adjacent 1-millisecond period, to determine a first idle time period in which no signal transmission is performed in the 1-millisecond period.

For ease of understanding, a manner of determining the first idle period is described with reference to an example.

The initiator device detects, in the blind detection manner in the 1-millisecond period divided into five time segments, that data transmission is performed in a first time segment, a third time segment, and a fourth time segment, to be specific, data transmission is performed in 0 to 0.2 milliseconds and 0.4 to 0.8 milliseconds; and that no data transmission is performed in a second time segment and a fifth time segment, to be specific, no data transmission is performed in 0.2 to 0.4 milliseconds and 0.8 to 1 milliseconds. In this case, first idle time periods in the 1-millisecond period are the second time segment and the fifth time segment.

It should be understood that, when a quantity of first idle periods determined by the initiator device is not less than 2, the initiator device determines the first indication information. The first indication information indicates the at least two first idle time segments in the time unit. When the initiator device determines that the quantity of first idle periods is less than 2, the initiator device enters a standby state, and waits to perform next CCA.

S420: A responder device performs CCA to obtain second indication information.

In an example, the responder device performs CCA on the UWB channel. The CCA is used to detect usage of the UWB channel in one time unit. The responder device determines the second indication information based on the usage of the UWB channel in the time unit. The second indication information indicates at least two second idle time segments in one time unit.

For example, in a manner similar to a manner in which the initiator device performs CCA, the responder device detects, in the blind detection manner and the like, a time segment for signal transmission in an adjacent 1-millisecond period, to determine a second idle time period in which no signal transmission is performed in the 1-millisecond period.

It should be understood that, when a quantity of second idle periods determined by the responder device is not less than 2, the responder device determines the second indication information. The second indication information indicates the at least two second target idle time segments in the time unit. When the responder device determines that the quantity of second idle periods is less than 2, the responder device enters a standby state, and waits to perform next CCA.

S430: The initiator device sends a first UWB signal on the UWB channel.

Correspondingly, the responder device receives the first UWB signal on the UWB channel.

In an example, the initiator device sends at least one segment signal of the first UWB signal in a first target idle time segment in each time unit, and uses the first UWB signal to perform data measurement. The at least two first idle time segments include the first target idle time segment.

It should be understood that, after obtaining the first indication information, the initiator device randomly selects, from the at least two first idle time segments indicated by the first indication information, one first idle time segment as the first target idle time segment, and sends the first UWB signal in the first target idle time segment.

It should be understood that, to increase transmit power of the first UWB signal, the first UWB signal may be sent in a plurality of segments in a sending process. Only one segment signal is sent in each millisecond to increase instantaneous transmit power.

For example, that the first UWB signal is sent in segments includes the initiator device divides the first UWB signal into N first segment signals, where a time length of each first segment signal is less than the first threshold (for example, less than one millisecond); and the initiator device sends one first segment signal to the responder device on the first UWB channel at an interval of the first threshold.

For ease of understanding, a manner of sending the first UWB signal in the first target idle time segment is described with reference to an example in which a length of one time unit is 1 millisecond.

When first idle time periods in the 1-millisecond period divided into five time segments are a second time segment and a fifth time segment, the initiator device randomly selects the second time segment or the fifth time segment to send the first UWB signal in a segment sending manner, to be specific, the initiator device separately sends the N first segment signals in the second time segment or the fifth time segment of each millisecond.

It should be understood that data measurement may be distance measurement, or data measurement may be data sensing, or the like. This is not limited in this application.

In a possible implementation, the communication method provided in this embodiment of this application is applied to a narrowband protocol-assisted UWB ranging scenario. Data measurement may be distance measurement, and the first UWB signal may be a UWB ranging signal.

In another possible implementation, the communication method provided in this embodiment of this application is applied to a narrowband protocol-assisted UWB sensing scenario. Data measurement may be data sensing, and the first UWB signal may be a UWB sensing signal.

It should be noted that the foregoing describes, by using examples, only scenarios to which the communication method provided in this application can be applied, and does not constitute any limitation on the protection scope of this application. The communication method provided in this application is further applied to another scenario, for example, a UWB measurement scenario in which measurement precision is related to signal bandwidth.

S440: The responder device sends a second UWB signal on the UWB channel.

Correspondingly, the initiator device receives the second UWB signal on the UWB channel.

In an example, the responder device sends at least one segment signal of the second UWB signal in a second target idle time segment in each time unit. The at least two second idle time segments include the second target idle time segment.

It should be understood that, after obtaining the second indication information, the responder device randomly selects, from the at least two second idle time segments indicated by the second indication information, one second idle time segment as the second target idle time segment, and sends the second UWB signal in the second target idle time segment.

In an example, in a data measurement process, when the initiator device sends the first UWB signal to the responder device, the responder device sends the second UWB signal to the initiator device. For example, the responder device replies with the second UWB signal in a segment transmission manner in a middle time period at which the initiator device sends two consecutive first segment signals.

For example, similar to that the first UWB signal is sent in segments, that the second UWB signal is sent in segments includes the following.

The responder device divides the second UWB signal into a plurality of second segment signals, where a time length of each second segment signal is less than the first threshold (for example, less than one millisecond); and the initiator device sends one second segment signal to the initiator device every one millisecond on the first UWB channel, where time at which the second segment signal is sent is a middle time period at which two adjacent first segment signals are received.

For example, that the first UWB signal and the second UWB signal are used to complete ranging may be understood as follows such as the initiator device sends the first UWB signal at a moment T1, the responder device estimates T2 (arrival time of a ranging signal from the initiator device) based on the first UWB signal, the responder device sends the second UWB signal at a moment T3, and the initiator device estimates T4 (arrival time of a ranging signal from the responder device) based on a ranging signal sent by the responder device. After sending the ranging signal, the responder device sends a data frame carrying T2 and T3. A distance between the initiator device and the responder device is estimated as follows:

$$d = \frac{( {T}_{1} - {T}_{4} ) - ( {T}_{3} - {T}_{2} )}{2} c ,$$

where c is a speed of light.

That the first UWB signal and the second UWB signal are used to complete sensing is similar to that the first UWB signal and the second UWB signal are used to complete ranging. A difference is as follows. In a ranging scenario, it focuses only on propagation time of a shortest path, and does not focus on information of other multipath signals; while in a sensing scenario, it needs to separately measure information such as transmission delays and incident angles of different multipath propagation signals, where the information may be obtained through calculation based on a channel impulse response (CIR), and the responder device may directly feed back a CIR result to the initiator device, or may feed back an estimated result of sensing information after calculation based on a CIR result.

In other words, in the ranging scenario, the measurement result may refer to T2 and T3 above, and in the sensing scenario, the measurement result may refer to the CIR result or an estimated result of sensing information.

It should be noted that, the foregoing merely describes, by using an example, how the first UWB signal and the second UWB signal are used to complete ranging or sensing, and does not constitute any limitation on the protection scope of this application. In this embodiment of this application, an principle of the first UWB signal and the second UWB signal being used to complete ranging or sensing is not limited. For details, refer to current related descriptions of implementing ranging or sensing by using a UWB signal.

Based on the foregoing solution, in a narrowband protocol-assisted UWB data measurement scenario, the initiator device and the responder device first perform channel assessment detection for one millisecond before sending the UWB signal, and determine, based on a result of the channel assessment detection, a time sequence for sending the UWB signal in segments. This avoids a case in which transmission time of a plurality of consecutive segment signals overlaps when a plurality of pairs of initiator devices and responder devices simultaneously perform UWB ranging or sensing. This avoids ranging interference and improves ranging performance.

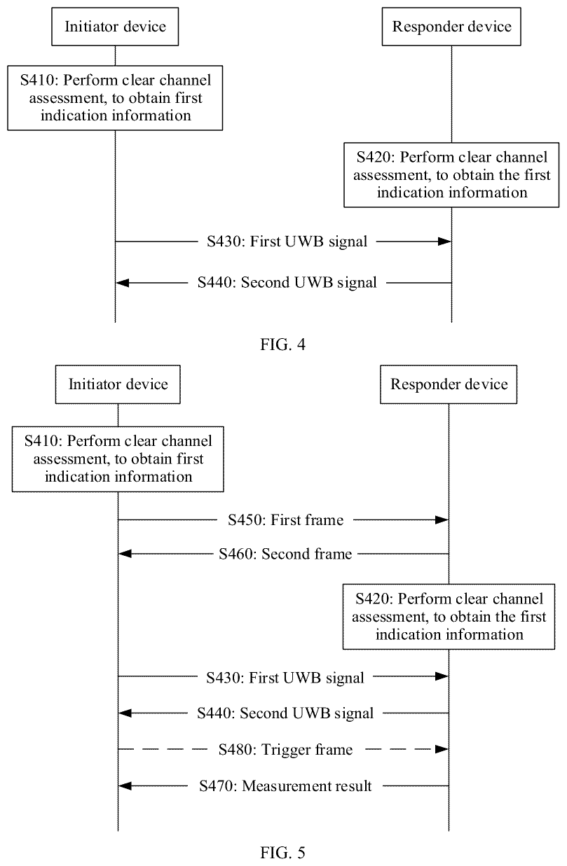

FIG. 5 is a schematic flowchart of an example of a communication method according to this application. For FIG. 5, refer to the description of FIG. 4. After step S410 in FIG. 4, the method further includes steps S450 and S460. After step S440 in FIG. 3, the method further includes steps S470 and S480.

After S410, the initiator device sends a first frame to the responder device, to start to perform data measurement. The method procedure shown in FIG. 4 may further include the following step.

S450: The initiator device sends the first frame to the responder device.

Correspondingly, the responder device receives the first frame from the initiator device.

In an example, the initiator device sends the first frame to the responder device on a narrowband channel. The first frame is used to trigger data measurement. It may be understood that, when data measurement needs to be performed between the initiator device and the responder device, a data measurement procedure may be triggered by using the first frame.

For example, the first frame may be referred to as an inquiry frame, a polling frame, a poll (poll) frame, or the like. It should be understood that a name of a frame or information is not limited in embodiments of this application.

Optionally, the first frame includes but is not limited to at least one of the following information such as the first indication information, identification information of the responder device, information indicating duration of the first UWB signal in each millisecond, information indicating an interval between time at which the first frame is sent and time at which the first UWB signal is sent, information indicating a quantity of segments of the first UWB signal, information indicating a total length of the first UWB signal, and information indicating a measurement result feedback type.

The identification information of the responder device identifies the responder device, and includes but is not limited to information that can identify the responder device, for example, an identifier (ID) of the responder device, attribute information of the responder device, or identification information of a device group to which the responder device belongs.

The duration of the first UWB signal in each millisecond indicates a time length of each segment signal in a case in which a to-be-sent first UWB signal is divided into a plurality of segment signals. For example, generally, the initiator device divides a to-be-transmitted UWB signal into a plurality of segment signals, where a time length of each segment signal is less than one millisecond, and then sends only one segment signal in each millisecond.

The interval between the time at which the first frame is sent and the time at which the first UWB signal is sent indicates a time length from time at which the first frame is sent to time at which the first UWB signal is sent next time. For example, if the interval between the time at which the first frame is sent and the time at which the first UWB signal is sent is 0.1 millisecond, the initiator device sends the first UWB signal 0.1 millisecond after the initiator device sends the first frame.

The quantity of segments of the first UWB signal indicates a quantity of segment signals in a case in which the to-be-sent first UWB signal is divided into a plurality of segment signals.

The total length of the first UWB signal indicates a time length of the to-be-sent first UWB signal.

The measurement result feedback type indicates a form in which the initiator device expects to feed back the received measurement result, and the measurement result feedback type includes but is not limited to a CIR, namely, amplitudes and phase information of different multipath signals; a differential CIR, namely, a difference between a channel impulse response and a last measurement result; or a channel measurement result, namely, an incident angle, a delay, and corresponding signal strength and phase information of each multipath signal.

Further, after receiving the first frame, the responder device may feed back a second frame to the initiator device in response to the first frame, so that the initiator device determines that data measurement can be performed. The method procedure shown in FIG. 5 further includes the following step.

S460: The responder device sends the second frame to the initiator device.

Correspondingly, the initiator device receives the second frame from the responder device.

In an example, if receiving the first frame on the narrowband channel, the responder device sends the second frame to the initiator device on the same narrowband channel. The second frame is used to respond to the first frame.

For example, the second frame may be referred to as a response frame.

Further, after the initiator device receives the second frame, the first UWB signal and the second UWB signal start to be transmitted to perform data measurement, that is, steps S430 and S440 are performed.

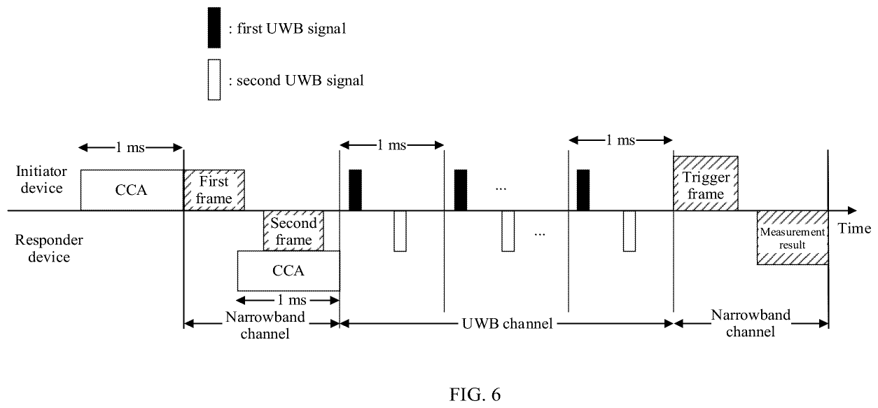

For ease of understanding, a time sequence relationship between performing CCA, sending the first frame, receiving the second frame, sending the first UWB signal, and receiving the second UWB signal is described with reference to FIG. 6. FIG. 6 is a diagram of a CCA-based UWB signal sending time sequence according to an embodiment of this application.

It can be learned from FIG. 6 that the initiator device first performs CCA, and then sends the first frame. After receiving the first frame, the responder device performs channel assessment detection and sends the second frame. After the responder device completes channel assessment detection, the initiator device and the responder device start to transmit the first UWB signal and the second UWB signal.

It should be noted that for specific processes of S430 and S440, refer to descriptions in FIG. 4. To avoid repetition, detailed descriptions thereof are omitted herein.

It should be noted that S430, that is, sending the first UWB signal, may be performed after S460, that is, receiving the second frame, or may be performed after S420, that is, CCA. This is not limited in this application.

Further, after transmission of the first UWB signal and the second UWB signal is completed and data measurement ends, the initiator device obtains a measurement result. The method procedure shown in FIG. 5 further includes the following step.

S470: The responder device sends the measurement result to the initiator device.

Correspondingly, the initiator device receives the measurement result from the responder device.

In an example, after data measurement ends, the responder device sends the measurement result to the initiator device.

Content included in the measurement result may be a CIR, a differential result of the CIR, an estimated sensing parameter including information such as an incident direction, a delay, and Doppler of each transmission path, timestamp information of arrival and departure of a channel, and the like. This is not limited.

In a possible implementation, the initiator device may send a trigger frame to the responder device, to trigger the responder device to send the measurement result to the initiator device.

Optionally, in S480, the initiator device sends the trigger frame to the responder device.

Correspondingly, the responder device receives the trigger frame from the initiator device.

In an example, the initiator device sends the trigger frame to the responder device on the narrowband channel. The trigger frame is used to trigger the responder device to report the measurement result.

Optionally, the trigger frame includes information indicating content included in the measurement result, and/or information indicating a form of the measurement result. The content included in the measurement result may be a channel impulse response CIR, a differential result of the CIR, an estimated sensing parameter including information such as an incident direction, a delay, and Doppler of each transmission path, timestamp information of arrival and departure of a channel, and the like. This is not limited. The form of the measurement result may refer to a form in which the measurement result is reported, for example, a binary form or a hexadecimal form. This is not limited.

It should be understood that after the responder device receives the trigger frame, the responder device sends, to the initiator device based on the measurement result content and/or form indicated by the trigger frame, a measurement result satisfying the measurement result content and/or form.

Based on the foregoing solution, in a narrowband protocol-assisted UWB data measurement scenario, the initiator device and the responder device first perform channel assessment detection for one millisecond before sending the UWB signal, and determine, based on a result of the channel assessment detection, a time sequence for sending the UWB signal in segments. This avoids a case in which transmission time of a plurality of consecutive segment signals overlaps when a plurality of pairs of initiator devices and responder devices simultaneously perform UWB ranging or sensing. This avoids ranging interference and improves ranging performance.

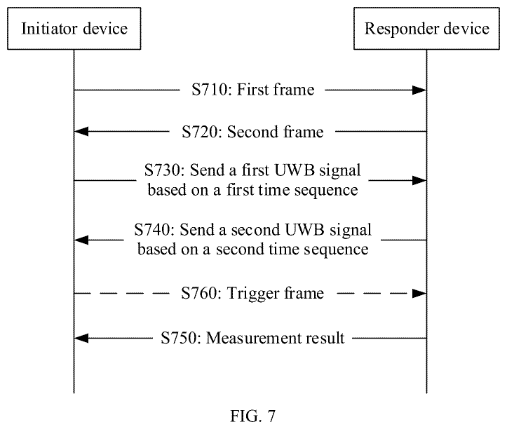

FIG. 7 is a schematic flowchart of a communication method according to an embodiment of this application. The method includes the following steps.

S710: An initiator device sends a first frame to a responder device.

Correspondingly, the responder device receives the first frame from the initiator device.

In an example, the initiator device sends the first frame to the responder device on a narrowband channel. The first frame is used to trigger data measurement. It may be understood that, when data measurement needs to be performed between the initiator device and the responder device, a data measurement procedure may be triggered by using the first frame.

For example, the first frame may be referred to as an inquiry frame, a polling frame, a poll (poll) frame, or the like. It should be understood that a name of a frame or information is not limited in embodiments of this application.

The first frame includes a first time sequence or a first key.

The first time sequence includes N elements, an i^{th} element indicates that sending time of an i^{th} first segment signal is located in a k^{th} time segment in an i^{th} time unit, any time unit is divided into K time segments, i is a positive integer less than or equal to N, and k is a random number less than or equal to K.

The time unit is equal to a first threshold (for example, 1 millisecond) in terms of time length.

Optionally, the first threshold may be predefined, or may be determined by a transceiver device through negotiation. The first threshold includes but is not limited to 1 millisecond, 0.5 millisecond, and the like. A specific value of the first threshold is not limited in embodiments of this application. For example, the value of the first threshold may be adjusted and set based on factors such as maximum power spectral density of a transmitted UWB signal and a power increase multiple for UWB-based segment transmission.

It should be understood that any time unit is divided into K time segments. For example, if a time length of a time unit is 1 millisecond, and the time unit is divided into five time segments, a time length of each time segment is 0.2 millisecond.

For example, if the first time sequence includes five elements, for example, [1, 5, 2, 4, 6], the i^{th} element indicates that the sending time of the i^{th} first segment signal is located in the k^{th} time segment in the i^{th} time unit. It may be understood that a first element “1” indicates that sending time of a 1^{st} first segment signal is located in a first time segment in a first time unit, and a second element “5” indicates that sending time of a 2^{nd} first segment signal is located in a fifth time segment in a second time unit.

The first key is used to generate the first time sequence. The first key includes a key by using an Advanced Encryption Standard (AES) AES128 encryption mechanism.

Optionally, the first frame further includes but is not limited to at least one of the following information such as identification information of the responder device, information indicating a quantity of segments of a first UWB signal, information indicating a total length of the first UWB signal, and information indicating a measurement result feedback type.

It should be noted that the foregoing information is described in detail in S450. To avoid repetition, detailed description thereof is omitted herein.

Further, after receiving the first frame, the responder device may feed back a second frame to the initiator device in response to the first frame. A method procedure shown in FIG. 7 further includes the following steps.

S720: The responder device sends the second frame to the initiator device.

Correspondingly, the initiator device receives the second frame from the responder device.

In an example, if receiving the first frame on the narrowband channel, the responder device sends the second frame to the initiator device on the same narrowband channel. The second frame is used to respond to the first frame.

For example, the second frame may be referred to as a response frame.

Further, after receiving the second frame, the initiator device may start data measurement. The method procedure shown in FIG. 7 further includes the following steps.

S730: The initiator device sends the first UWB signal to the responder device based on the first time sequence.

Correspondingly, the responder device receives the first UWB signal sent by the initiator device based on the first time sequence.

In an example, the initiator device sends the first UWB signal in a segment sending form based on the k^{th} time segment of the sending time of the i^{th} first segment signal indicated by the i^{th} element in the first time sequence.

It should be understood that, to increase transmit power of the first UWB signal, the first UWB signal may be sent in a plurality of segments in a sending process. Only one segment signal is sent in each millisecond to increase instantaneous transmit power.

For example, that the first UWB signal is sent in segments includes the initiator device divides the first UWB signal into N first segment signals, where a time length of each first segment signal is less than the first threshold (for example, less than one millisecond); and the initiator device sends one first segment signal to the responder device on the first UWB channel at an interval of the first threshold.

It should be understood that the first threshold includes but is not limited to 1 millisecond, 0.5 millisecond, and the like. This is not limited.

For ease of understanding, a manner in which the initiator device sends the first UWB signal to the responder device based on the first time sequence is described with reference to an example.

For example, the first UWB signal includes five first segment signals, a time unit whose time length is 1 millisecond is divided into 10 time segments, and the first time sequence includes five elements such as [1, 5, 2, 4, 6]. In this case, sending time of a 1^{st} first segment signal is located in a first time segment in a first time unit, sending time of a 2^{nd} first segment signal is located in a fifth time segment in a second time unit, and sending time of a 3^{rd} first segment signal is located in a second time segment in a third time unit.

Optionally, when the first frame includes the first key, the initiator device generates the first time sequence based on the first key, and sends the first UWB signal to the responder device based on the first time sequence.

In an example, the initiator device obtains the first time sequence based on the first key by using an AES128 encryption algorithm, and sends the first UWB signal to the responder device based on the first time sequence.

Optionally, the initiator device inserts a guard interval between time hopping segments in two adjacent milliseconds.

It should be understood that if a time interval between two time hopping segments in two consecutive milliseconds is less than 1 millisecond, the guard interval is inserted between the two milliseconds. The guard interval is 1 millisecond. Within the guard interval, the initiator device does not send a plurality of first segment signals of the first UWB signal.

S740: The responder device sends a second UWB signal to the initiator device based on a second time sequence.

Correspondingly, the initiator device receives the second UWB signal sent by the responder device based on the second time sequence.

In an example, the initiator device sends the second UWB signal in a segment sending form based on a k^{th} time segment of sending time of an i^{th} second segment signal indicated by an i^{th} element in the second time sequence.

For example, similar to that the first UWB signal is sent in segments, that the second UWB signal is sent in segments includes the following.

The responder device divides the second UWB signal into a plurality of second segment signals, where a time length of each second segment signal is less than the first threshold (for example, less than 1 millisecond); and the initiator device sends one second segment signal to the initiator device on the first UWB channel every 1 millisecond.

For ease of understanding, a manner in which the responder device sends the second UWB signal to the initiator device based on the second time sequence is described with reference to an example.

For example, the second UWB signal includes five second segment signals, a time unit whose time length is 1 millisecond is divided into 10 time segments, and the second time sequence includes five elements such as [2, 6, 3, 5, 7]. In this case, sending time of a 1^{st} second segment signal is located in a second time segment in a first time unit, sending time of a 2^{nd} second segment signal is located in a sixth time segment in a second time unit, and sending time of a 3^{rd} second segment signal is located in a third time segment in a third time unit.

Optionally, when the first frame includes the first key, the responder device generates the first time sequence based on the first key, generates the second time sequence based on the first time sequence, and sends the second UWB signal to the initiator device based on the second time sequence.

In an example, the responder device obtains the first time sequence based on the first key by using the AES128 encryption algorithm, and obtains, based on the first time sequence, the second time sequence different from the first time sequence.

For example, the first key is a key based on the AES128 encryption algorithm. The responder device generates, based on the AES128 standard and the first key, the first time sequence, for example, [1, 5, 2, 4, 6], and generates, based on the first time sequence in a manner of adding 1 to each element in the first time sequence, the second time sequence such as [2, 6, 3, 5, 7].

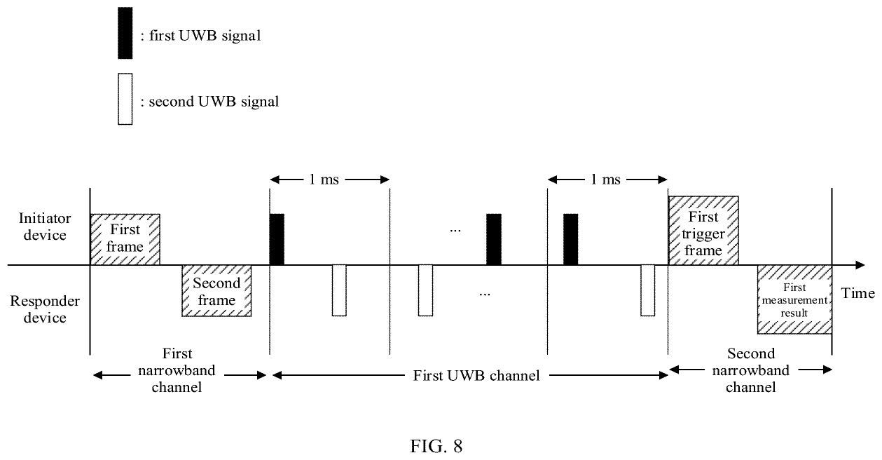

For ease of understanding, a time sequence relationship between sending the first frame, receiving the second frame, sending the first UWB signal based on the first time sequence, and receiving the second UWB signal sent based on the first time sequence is described with reference to FIG. 8. FIG. 8 is a diagram of a time hopping-based UWB signal sending time sequence according to an embodiment of this application.

It can be learned from FIG. 8 that, after the initiator device sends the first frame and receives the second frame, the initiator device and the responder device respectively start to transmit the first UWB signal and the second UWB signal based on the first time sequence and the second time sequence.

Further, after transmission of the first UWB signal and the second UWB signal is completed and data measurement ends, the initiator device obtains a measurement result. The method procedure shown in FIG. 7 further includes the following steps.

S750: The responder device sends the measurement result to the initiator device.

Correspondingly, the initiator device receives the measurement result from the responder device.

In an example, after data measurement ends, the responder device sends the measurement result to the initiator device.

Content included in the measurement result may be a CIR, a differential result of the CIR, an estimated sensing parameter including information such as an incident direction, a delay, and Doppler of each transmission path, timestamp information of arrival and departure of a channel, and the like. This is not limited.

In a possible implementation, the initiator device may send a trigger frame to the responder device, to trigger the responder device to send the measurement result to the initiator device.

Optionally, in S760, the initiator device sends the trigger frame to the responder device.

Correspondingly, the responder device receives the trigger frame from the initiator device.

In an example, the initiator device sends the trigger frame to the responder device on the narrowband channel. The trigger frame is used to trigger the responder device to report the measurement result.

Optionally, the trigger frame includes information indicating content included in the measurement result, and/or information indicating a form of the measurement result. The content included in the measurement result may be a channel impulse response CIR, a differential result of the CIR, an estimated sensing parameter including information such as an incident direction, a delay, and Doppler of each transmission path, timestamp information of arrival and departure of a channel, and the like. This is not limited. The form of the measurement result may refer to a form in which the measurement result is reported, for example, a binary form or a hexadecimal form. This is not limited.

It should be understood that after the responder device receives the trigger frame, the responder device sends, to the initiator device based on the measurement result content and/or form indicated by the trigger frame, a measurement result satisfying the measurement result content and/or form.

Based on the foregoing solution, in a narrowband protocol-assisted UWB data measurement scenario, the initiator device and the responder device separately send UWB signals in random time segments based on a time sequence including a random number. This avoids a case in which transmission time of a plurality of consecutive segment signals overlaps when a plurality of pairs of initiator devices and responder devices simultaneously perform UWB ranging or sensing. This avoids ranging interference and improves ranging performance.

It should be understood that sequence numbers of the foregoing processes do not mean execution sequences. The execution sequences of the processes should be determined based on functions and internal logic of the processes, and should not be construed as any limitation on implementation processes of embodiments of this application.

It should be further understood that, in embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It should be further understood that in some of the foregoing embodiments, a device (for example, the initiator device and the responder device) in a conventional network architecture is mainly used as an example for description. It should be understood that a specific form of the device is not limited in embodiments of this application. For example, all devices that can implement a same function in the future are applicable to embodiments of this application.

It may be understood that, in the foregoing method embodiments, the method and the operation implemented by the device (for example, the initiator device and the responder device) may also be implemented by a component (for example, a chip or a circuit) of the device.

The foregoing describes in detail the communication method provided in embodiments of this application with reference to FIG. 4, FIG. 5, and FIG. 7. The foregoing communication method is mainly described from a perspective of interaction between the initiator device and the responder device. It may be understood that, to implement the foregoing functions, the initiator device and the responder device include corresponding hardware structures and/or software modules for performing the functions.

A person skilled in the art should be able to be aware that, in combination with units and algorithm steps of the examples described in embodiments disclosed in this specification, this application may be implemented by hardware or a combination of hardware and computer software. Whether a function is performed by the hardware or hardware driven by computer software depends on particular applications and design constraints of the technical solutions. A person skilled in the art may use different methods to implement the described functions for each particular application, but it should not be considered that the implementation goes beyond the scope of this application.

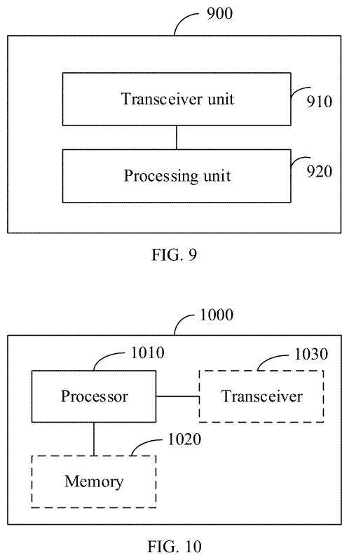

The following describes communication apparatuses that are provided in embodiments of this application with reference to FIG. 9 and FIG. 10. It should be understood that descriptions of apparatus embodiments correspond to the descriptions of the method embodiments. Therefore, for content that is not described in detail, refer to the foregoing method embodiments. For brevity, some content is not described again.

In embodiments of this application, an initiator device or a responder device may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used. Descriptions are provided below by using an example in which each functional module is obtained through division based on each corresponding function.

FIG. 9 is a block diagram of a communication apparatus according to an embodiment of this application. As shown in FIG. 9, the apparatus 900 may include a transceiver unit 910 and a processing unit 920. The transceiver unit 910 may communicate with the outside, and the processing unit 920 is configured to process data. The transceiver unit 910 may also be referred to as a communication interface or a communication unit.

Optionally, the apparatus 900 may further include a storage unit. The storage unit may be configured to store instructions and/or data. The processing unit 920 may read the instructions and/or the data in the storage unit, so that the apparatus implements the foregoing method embodiment.

The apparatus 900 may be configured to perform actions performed by a transceiver device (for example, the initiator device and the responder device) in the foregoing method embodiment. In this case, the apparatus 900 may be the transceiver device or a component that can be configured in the transceiver device. The transceiver unit 910 is configured to perform receiving and sending related operations of the transceiver device in the foregoing method embodiment, and the processing unit 920 is configured to perform processing related operations of the transceiver device in the foregoing method embodiment.

In a design, the apparatus 900 is configured to perform actions performed by the initiator device in the foregoing method embodiment.

In a possible implementation, the processing unit 920 is configured to perform CCA on a UWB channel to obtain first indication information. The first indication information indicates at least two first idle time segments in one time unit. The transceiver unit 910 is configured to send at least one segment signal of a first UWB signal in a first target idle time segment in each time unit. The first UWB signal is used to perform data measurement, and the at least two first idle time segments include the first target idle time segment.

In another possible implementation, the transceiver unit 910 is configured to send the first UWB signal on an UWB channel based on a first time sequence. The first UWB signal includes N first segment signals, the first time sequence includes N elements, an i^{th} element indicates that sending time of an i^{th} first segment signal is located in a k^{th} time segment in an i^{th} time unit, any time unit is divided into K time segments, i is a positive integer less than or equal to N, and k is a random number less than or equal to K. The transceiver unit 910 is further configured to receive a second UWB signal on the UWB channel. The first UWB signal and the second UWB signal are used to perform data measurement.

The apparatus 900 may implement steps or procedures performed by the initiator device in the method embodiments according to embodiments of this application. The apparatus 900 may include units configured to perform the methods performed by the initiator device in the method embodiments. In addition, the units in the apparatus 900 and the foregoing other operations and/or functions are separately used to implement corresponding procedures in the method embodiments of the initiator device in the method embodiments.

When the apparatus 900 is configured to perform the method in FIG. 5, the transceiver unit 910 may be configured to perform receiving and sending steps in the method, for example, steps S430, S440, S450, S460, S470, and S480. The processing unit 920 may be configured to perform processing steps in the method, for example, steps S410 and S420.

It should be understood that a process in which the units perform the foregoing corresponding steps is described in the foregoing method embodiments. For brevity, details are not described herein.

In another design, the apparatus 900 is configured to perform actions performed by the responder device in the foregoing method embodiments.

In a possible implementation, the transceiver unit 910 is configured to receive at least one segment signal of the first UWB signal in the first target idle time segment in each time unit. The processing unit 920 is configured to perform CCA on the UWB channel to obtain second indication information. The second indication information indicates at least two second target idle time segments in one time unit. The transceiver unit 910 is further configured to send at least one segment signal of the second UWB signal in a second target idle time segment in each time unit. The at least two second idle time segments include the second target idle time segment. The processing unit 920 is further configured to perform data measurement based on the first UWB signal and the second UWB signal.

In another possible implementation, the transceiver unit 910 is configured to receive the first UWB signal on the UWB channel. The transceiver unit 910 is further configured to send the second UWB signal on the UWB channel based on a second time sequence. The first UWB signal and the second UWB signal are used to perform data measurement. The second time sequence is generated based on the first time sequence. The first time sequence includes N elements, an i^{th} element indicates that sending time of an i^{th} second segment signal is located in a k^{th} time segment in an i^{th} time unit, any time unit is divided into K time segments, i is a positive integer less than or equal to N, and k is a random number less than or equal to K.

The apparatus 900 may implement the steps or procedures performed by the responder device in the method embodiments according to embodiments of this application. The apparatus 900 may include units configured to perform the methods performed by the responder device in the method embodiments. In addition, the units in the apparatus 900 and the foregoing other operations and/or functions are separately used to implement corresponding procedures in the method embodiments of the responder device in the method embodiments.

When the apparatus 900 is configured to perform the method in FIG. 5, the transceiver unit 910 may be configured to perform receiving and sending steps in the method, for example, steps S430, S440, S450, S460, S470, and S480. The processing unit 920 may be configured to perform processing steps in the method, for example, steps S410 and S420.

It should be understood that a process in which the units perform the foregoing corresponding steps is described in the foregoing method embodiments. For brevity, details are not described herein.

The processing unit 920 in the foregoing embodiments may be implemented by at least one processor or processor-related circuit. The transceiver unit 910 may be implemented by using a transceiver or a transceiver-related circuit. The storage unit may be implemented by at least one memory.

As shown in FIG. 10, an embodiment of this application further provides an apparatus 1000. The apparatus 1000 includes a processor 1010, and may further include one or more memories 1020. The processor 1010 is coupled to the memory 1020. The memory 1020 is configured to store a computer program or instructions and/or data. The processor 1010 is configured to execute the computer program or the instructions and/or the data stored in the memory 1020, so that the methods in the foregoing method embodiments are performed. Optionally, the apparatus 1000 includes one or more processors 1010.

Optionally, the memory 1020 and the processor 1010 may be integrated together or separately disposed.

Optionally, as shown in FIG. 10, the apparatus 1000 may further include a transceiver 1030. The transceiver 1030 is configured to receive and/or send a signal. For example, the processor 1010 is configured to control the transceiver 1030 to receive and/or send the signal.

In a solution, the apparatus 1000 is configured to implement operations performed by a transceiver device (for example, an initiator device and a responder device) in the foregoing method embodiments.

An embodiment of this application further provides a computer-readable storage medium. The computer-readable storage medium stores computer instructions used to implement the method performed by a transceiver device (for example, an initiator device and a responder device) in the foregoing method embodiments.

For example, when a computer program is executed by a computer, the computer can implement the methods performed by the transceiver device (for example, the initiator device and the responder device) in the foregoing method embodiments.

An embodiment of this application further provides a computer program product including instructions. When the instructions are executed by a computer, the computer is enabled to implement the methods performed by a transceiver device (for example, an initiator device and a responder device) in the foregoing method embodiments.

An embodiment of this application further provides a communication system. The communication system includes the initiator device and the responder device in the foregoing embodiments.

For explanations and beneficial effect of related content in any apparatus provided above, refer to the corresponding method embodiments provided above. Details are not described herein again.

It should be understood that, the processor mentioned in embodiments of this application may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of this application may be a volatile memory and/or a nonvolatile memory. The nonvolatile memory may be a read-only memory (ROM), a programmable ROM (PROM), an erasable PROM (EPROM), an electrically erasable PROM (EEPROM), or a flash memory. The volatile memory may be a random access memory (RAM). For example, the RAM can be used as an external cache. By way of example, and not limitation. The RAM may include the following plurality of forms such as a static RAM (SRAM), a dynamic RAM (DRAM), a synchronous DRAM (SDRAM), a double data rate synchronous DRAM (DDR SDRAM), an enhanced synchronous DRAM (ESDRAM), a synchlink DRAM (SLDRAM), and a direct rambus RAM (DR RAM).

It should be noted that when the processor is a general-purpose processor, a DSP, an ASIC, an FPGA or another programmable logic device, a discrete gate or a transistor logic device, or a discrete hardware component, a memory (storage module) may be integrated into the processor.

It should further be noted that the memory described herein is intended to include, but is not limited to, these and any other suitable type of memory.

A person of ordinary skill in the art may be aware that, in combination with the examples described in embodiments disclosed in this specification, units and steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

In the several embodiments provided in this application, it should be understood that the disclosed apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to implement the solutions provided in this application.

In addition, functional units in embodiments of this application may be integrated into one unit, each of the units may exist alone physically, or two or more units may be integrated into one unit.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer instructions. When the computer program instructions are loaded and executed on a computer, the procedure, or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like. For example, the usable medium may include but is not limited to any medium that can store program code, for example, a Universal Serial Bus (USB) flash drive, a removable hard disk, a ROM, a RAM, a magnetic disk, or an optical disc.

The foregoing descriptions are example implementations of this application, and are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A ranging or sensing method, comprising:
performing clear channel assessment (CCA) on an ultra-wideband (UWB) channel to obtain first indication information, wherein the first indication information indicates at least two idle time segments in one time unit; and
sending at least one segment signal of a first UWB signal in a first target idle time segment in each time unit, wherein the first UWB signal is for performing data measurement, and wherein the at least two idle time segments comprise the first target idle time segment.

2. The ranging or sensing method of claim 1, wherein sending the at least one segment signal of the first UWB signal in the first target idle time segment in each of the time units comprises sending a first segment signal of the first UWB signal in the first target idle time segment in each of the time units.

3. The ranging or sensing method of claim 1, wherein after performing the CCA on the UWB channel, the ranging or sensing method further comprises sending a first frame on a narrowband channel, wherein the first frame is for triggering performance of the data measurement.

4. The ranging or sensing method of claim 3, wherein the first frame comprises at least one of the first indication information, identification information of a responder device, information indicating duration of the first UWB signal in each of the time units, information indicating an interval between a first time at which the first frame is sent and a second time at which the first UWB signal is sent, information indicating a quantity of segments of the first UWB signal, information indicating a total length of the first UWB signal, or information indicating a data measurement result feedback type.

5. The ranging or sensing method of claim 3, further comprising receiving a second frame on the narrowband channel, wherein the second frame is for responding to the first frame.

6. The ranging or sensing method of claim 1, further comprising obtaining a time segment for sending the first UWB signal based on the CCA.

7. The ranging or sensing method of claim 1, further comprising receiving a second UWB signal on the UWB channel, wherein the second UWB signal is for performing the data measurement.

8. A ranging or sensing method, comprising:
receiving at least one segment signal of a first ultra-wideband (UWB) signal in a first target idle time segment in each time unit;
performing clear channel assessment (CCA) on an UWB channel to obtain second indication information, wherein the second indication information indicates at least two idle time segments in one time unit;
sending at least one segment signal of a second UWB signal in a second target idle time segment in each of the time units, wherein the at least two idle time segments comprise the second target idle time segment; and
performing data measurement based on the first UWB signal and the second UWB signal.

9. The ranging or sensing method of claim 8, wherein sending the at least one segment signal of the second UWB signal in the second target idle time segment in each of the time units comprises sending a first segment signal of the second UWB signal in the second target idle time segment in each of the time units.

10. The ranging or sensing method of claim 8, further comprising receiving a first frame on a narrowband channel, wherein the first frame is for triggering performance of the data measurement.

11. The ranging or sensing method of claim 10, wherein the first frame comprises at least one of first indication information, identification information of a responder device, information indicating duration of the first UWB signal in each of the time units, information indicating an interval between a first time at which the first frame is sent and a second time at which the first UWB signal is sent, information indicating a quantity of segments of the first UWB signal, information indicating a total length of the first UWB signal, or information indicating a data measurement result feedback type, wherein the first indication information indicates at least two second idle time segments in one time unit, and wherein the second target idle time segment is different from the first target idle time segment.

12. The ranging or sensing method of claim 10, further comprising sending a second frame on the narrowband channel, wherein the second frame is for responding to the first frame.

13. The ranging or sensing method of claim 8, further comprising obtaining a time segment for sending the first UWB signal based on the CCA.

14. A ranging or sensing apparatus, comprising:
a memory configured to store instructions;
at least one processor configured to execute the instructions that cause the ranging or sensing apparatus to perform clear channel assessment (CCA) on an ultra-wideband (UWB) channel to obtain first indication information, wherein the first indication information indicates at least two idle time segments in one time unit; and
a transceiver coupled to the at least one processor and configured to send at least one segment signal of a first UWB signal in a first target idle time segment in each time unit, wherein the first UWB signal is for performing data measurement, and wherein the at least two idle time segments comprise the first target idle time segment.

15. The ranging or sensing apparatus of claim 14, wherein the transceiver is further configured to send a first segment signal of the first UWB signal in the first target idle time segment in each of the time units.

16. The ranging or sensing apparatus of claim 14, wherein after performing CCA on the UWB channel, the transceiver is further configured to send a first frame on a narrowband channel, wherein the first frame is for triggering performance of the data measurement.

17. The ranging or sensing apparatus of claim 16, wherein the transceiver is further configured to receive a second frame on the narrowband channel, and wherein the second frame is for responding to the first frame.

18. The ranging or sensing apparatus of claim 16, wherein the first frame comprises at least one of the first indication information, identification information of a responder device, information indicating duration of the first UWB signal in each of the time units, information indicating an interval between time at which the first frame is sent and time at which the first UWB signal is sent, information indicating a quantity of segments of the first UWB signal, information indicating a total length of the first UWB signal, or information indicating a data measurement result feedback type.

19. The ranging or sensing apparatus of claim 18, wherein the first indication information indicates at least two second idle time segments in one time unit.

20. The ranging or sensing apparatus of claim 14, wherein the transceiver is further configured to receive a second UWB signal on the UWB channel, and wherein the second UWB signal is for performing the data measurement.
